(19) United States
(12) Patent Application Publication
(10) Pub. No.: US 2024/0202631 A1
(43) Pub. Date: Jun. 20, 2024

(54) Machine Learning Systems and Methods for Validating Workflows

(71) Applicant: Insurance Services Office, Inc., Jersey City, NJ (US)

(72) Inventors: Samuel Warren, Salt Lake City, UT (US); Matthew D. Frei, Lehi, UT (US); Nicholas Sykes, American Fork, UT (US); David Baryuding, Bostan, MA (US); Sihui Shao, Everyville, CA (US); Bhumika Agrawal, San Francisco, CA (US); Jeffrey Beaulieu, Georgetown, TX (US); Ravi Shankar, Fremont, CA (US)

(73) Assignee: Insurance Services Office, Inc., Jersey City, NJ (US)

(21) Appl. No.: 18/542,209

(22) Filed: Dec. 15, 2023

Related U.S. Application Data
(60) Provisional application No. 63/433,082, filed on Dec. 16, 2022.

(51) Int. Cl. G06Q 10/0633; G06Q 10/0631; G06V 10/776; G06V 20/40

(52) U.S. Cl. CPC G06Q 10/0633; G06Q 10/063114; G06V 10/776; G06V 20/41; G06V 2201/10

(57) ABSTRACT

Machine learning systems and methods for validating workflows are provided. The system receives one or more digital images of a work action being performed, and processes the image using a hierarchical modeling process that includes a filter model and a cascaded expert model. The filter model processes the image to ascertain whether the image is suitable for use in validating completion of the work action. If the system determines that the image is suitable, the image is then processed by the expert model to classify whether the image depicts a scene occurring before, during, or after performance of the work action. The hierarchical modeling process can be utilized to validate different workflows based upon a specified workflow type. A plurality of hierarchical modeling processes can be applied in parallel to an input image in the event that a type of workflow to be validated is not specified in advance.

### RELATED APPLICATIONS

This application claims priority to U.S. Provisional Patent Application Ser. No. 63/433,082 filed on Dec. 16, 2022, the entire disclosure of which is hereby expressly incorporated by reference.

### BACKGROUND

### Technical Field

The present disclosure relates to the field of machine learning. More specifically, the present disclosure relates to machine learning systems and methods for validating workflows.

### Related Art

In the field of insurance claims processing, various software-based systems have been developed which allow users, such as banks and other entities, to manage property maintenance and repair activities in a convenient, software-based environment. One example of such a system is the Property Preservation Wizard (“PPW”) software system developed by Verisk Analytics, Inc. Such a system allows dispatching contractors to fulfill work orders for jobs such as lawn cuts, snow and ice removal, winterization, and much more.

A particular drawback of the foregoing systems is that they rely heavily on human activities to be completed and for data associated with validation of workflow completion to be manually entered by users. For example, such systems requires contractors to carefully document their work by capturing before, during, and after work images (e.g., often using the PPW mobile application). These photos are then manually reviewed by customers of PPW, who validate that work was properly completed before payment is released to the contractors.

The ever-expanding field of machine learning (ML) and artificial intelligence (AI) provides significant technological advantages that can be integrated into the aforementioned software systems in order to improve the functionality of such systems and to more rapidly and efficiently perform validation of workflows associated with completion of assigned jobs. Specifically, it would be beneficial to incorporate AI/ML technology in order to automate the human review process and integrate it into the PPW application to reduce the need for manual work validation—thereby reducing costs for customers, the time before contractors can be paid, and improving the speed with which such systems can process workflow data. Accordingly, the machine learning systems and methods disclosed herein address these and other needs.

### SUMMARY

The present disclosure relates to machine learning systems and methods for validating workflows. The system receives one or more digital images of a work action being performed, and processes the image using a hierarchical modeling process that includes a first machine learning (“filter”) model and a cascaded second machine learning (“expert”) model. The filter model processes the image to ascertain whether the image is suitable for use in validating completion of the work action. If the system determines that the image is suitable, the image is then processed by the expert model to classify whether the image depicts a scene occurring before, during, or after performance of the work action. The hierarchical modeling process can be utilized to validate different workflows, such that a particular hierarchical modeling process can be applied based upon a specified workflow type. Additionally, a plurality of hierarchical modeling processes can be applied in parallel to an input image in the event that a type of workflow to be validated is not specified in advance.

### BRIEF DESCRIPTION OF THE DRAWINGS

The foregoing features of the invention will be apparent from the following Detailed Description, taken in connection with the accompanying drawings, in which:

FIG. 1 is a diagram illustrating the system of the present disclosure;

FIG. 2 is a flowchart illustrating processing steps carried out by the system of FIG. 1;

FIG. 3 is a flowchart illustrating processing by the system of an input image based upon a pre-defined workflow type; and

FIG. 4 is a flowchart illustrating processing by the system of an input image using a plurality of hierarchical modeling processes executed in parallel where the type of workflow to be validated is not specified in advance.

### DETAILED DESCRIPTION

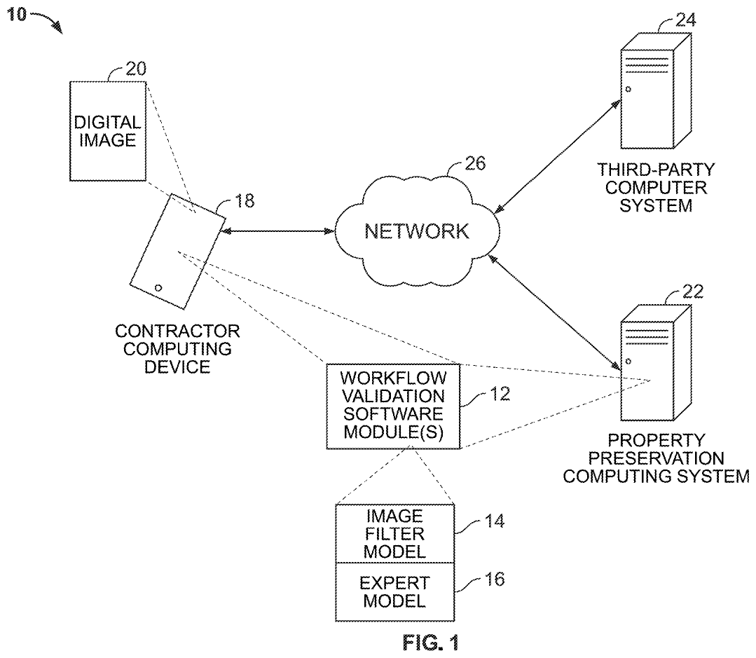

The present disclosure relates to machine learning systems and methods for validating workflows, as described in detail below in connection with FIGS. 1-4.

FIG. 1 is a diagram illustrating the system of the present disclosure, indicated generally at 10. The system 10 includes one or more workflow validation software modules 12 that are stored on or executed by a contractor computing device 18 and/or a property preservation computing system 22. The contractor computing device 18 could be a mobile telephone, a tablet computer, a personal computer, or other suitable computing device operated by a contractor. The property preservation computing system 22 could be a server, cloud-based computing platform, or other type of computing system which executes property preservation workflow software, such as the Verisk PPW system mentioned above. The module(s) 12 include an image filter model 14 and an expert model 16, which are machine learning models described in further detail below. The module(s) 12 could be programmed using any suitable programming language including, but not limited to, Java, Javascript, C, C++, C #, Python, or other suitable high- or low-level computing language. The module(s) 12 could be embodied as non-transitory, computer-readable instructions stored in a computer readable storage medium and executed by a processor in communication with the storage medium, such as a processor of the contractor computing device 18 and/or the computing system 22.

During operation, a digital image 20 is taken by the contractor computing device 18 in connection with performance of work action by a contractor. The digital image 20 is then processed by the models 14 and 16 of module(s) 12 to classify whether the digital image 20 depicts a scene occurring before, during, or after performance of the work action by the contractor. The classification can then be processed by the computing system 22 to automatically determine whether the work action has been completed by the contractor, thereby validating the work action (validating the workflow) and not requiring any manual input or human intervention to perform the validation. This significantly improves the speed and accuracy of workflow processing software executed by the computing system 12, as no human or manual input is required to complete processing of the workflow. Additionally, information about the image classification and/or the workflow being validated by the system can be transmitted to one or more third-party computer systems 24, such as an insurer computer system, a bank computer system, etc.

The outputs of the system can be utilized to validate the location of an image, for example, or to check other image forensics to verify that work was completed properly. Advantageously, the speed of validation provided by the systems and methods of the present disclosure allow for faster payments to contractors as well as speeding up daily workflows. Still further, the system can learn (e.g., via machine learning) as validations are conducted by the system, so as to improve the speed and accuracy of future validations conducted by the system.

Additionally, the systems and methods of the present disclosure can perform location validation and image forensics (e.g., the location of where an image was taken (e.g., using GPS coordinates or other location information) could be processed to verify that an image was actually taken at a location where work is described as having been performed. In addition to performing verification via the semantic information contained within the image data, the system can utilize metadata contained within the input images in order to identify the location where an image was taken (e.g., metadata usually associated with but not limited to JPG file types contains information such as GPS coordinates and time/date of capture). The system can utilize this information to ensure that the location matches the address of a given property and the time/data of the proposed work order.

It is further noted that the models described herein could include layers such, as but not limited to, convolutional layers, residual blocks, attention layers, pooling layers, batch normalization, fully connected layers & loss functions. For some workflows, it is of high importance for the model hierarchy to give an appropriate measure of prediction certainty. As such, for the filter model, expert model, or both models, the Laplace Redux method may be utilized. The Laplace Redux (LA) allows of an additional measure of uncertainty for a given input if required.

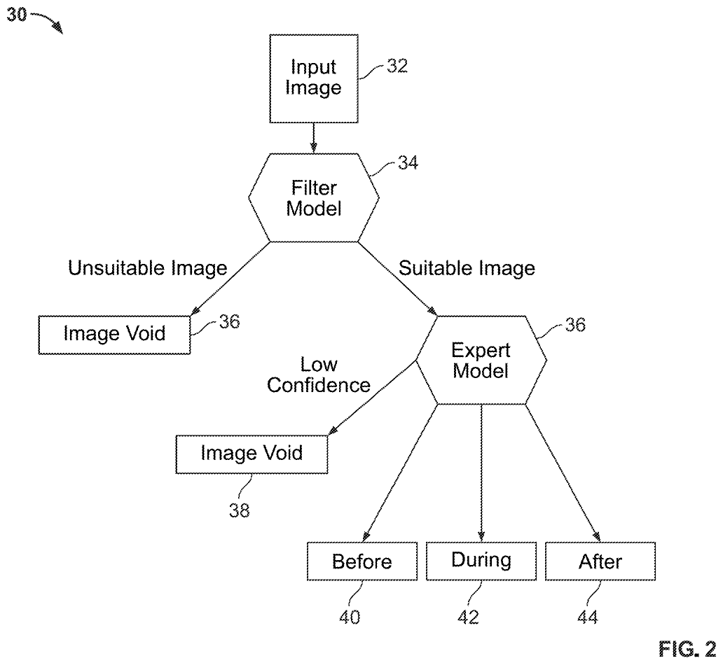

FIG. 2 is a flowchart illustrating processing steps carried out by the system of FIG. 1. Specifically, FIG. 2 illustrates a hierarchical modeling process 30 capable of being carried out by the module(s) 12 of FIG. 1, in order to validate a workflow (to validate whether a work action has been completed). The hierarchical modeling process 30 includes a first (“filter”) machine learning model and a cascaded second (“expert”) machine learning model. Beginning in step 32, the process 30 receives as input a digital image, such as the digital image 20 of FIG. 1 taken by the contractor computing device 18. In step 34, the image is processed by a first (“filter”) machine learning model, such as the filter model 14 of FIG. 1. In this step, the filter model determines whether the image is suitable for validating whether a work action has been completed. If not, the image is marked in step 36 as “void” and not utilized in connection with any further processing by the system. Otherwise, step 38 occurs, wherein the image is then processed by a second cascaded (“expert”) machine learning model, such as the expert model 16 of FIG. 1. The expert model scores the image, and if the score indicates a low confidence level, step 38 occurs, wherein the image is marked as void and is not utilized for further processing by the system. If the confidence level is not low, the image is classified as either depicting a scene that occurs before (step 40), during (step 42), or after (step 44) performance of a work action, depending on the value of the confidence level generated by the expert model in step 36. The classifications generated in steps 40-44 can then be processed by the system (e.g., by the computer system 22) to validate completion of the work action (e.g., to validate the workflow).

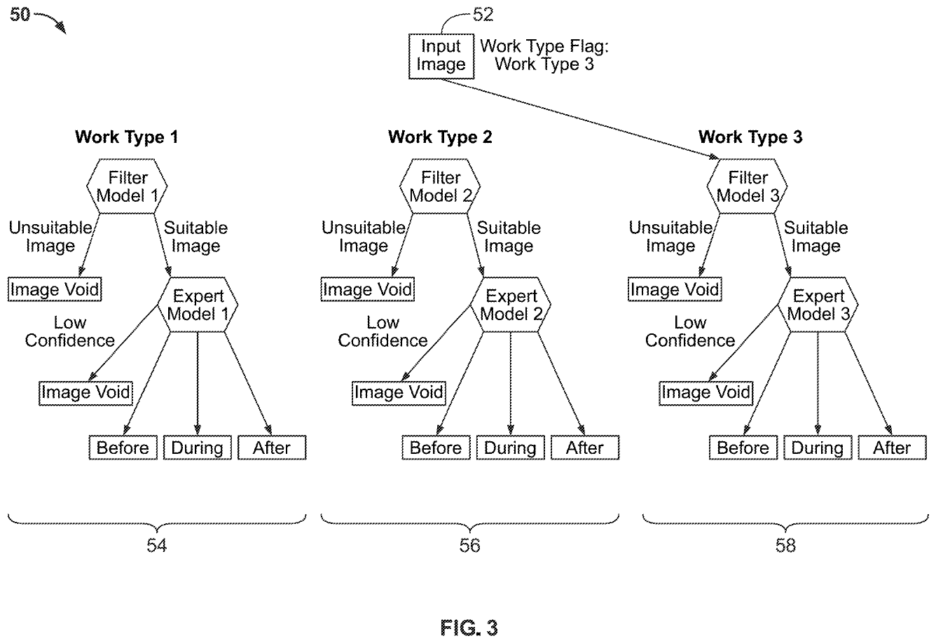

FIG. 3 is a flowchart 50 illustrating processing by the system of an input image based upon a pre-defined workflow type. Specifically, in step 52, a pre-defined workflow type associated with a work action is ascertained by the system. If the work flow is of a first type, a first hierarchical machine learning process 54 tailored for the first work flow type could be executed. Alternatively, if the work flow is of a second or a third work flow type, second or third hierarchical machine learning processes 56, 58 could be executed by, each tailored for the second or third work flow type, respectively. Importantly, the hierarchical workflow processes 54, 56, and 58 are similar to the process 30 of FIG. 2, in that each includes cascaded filter and expert models as described above in connection with FIG. 2.

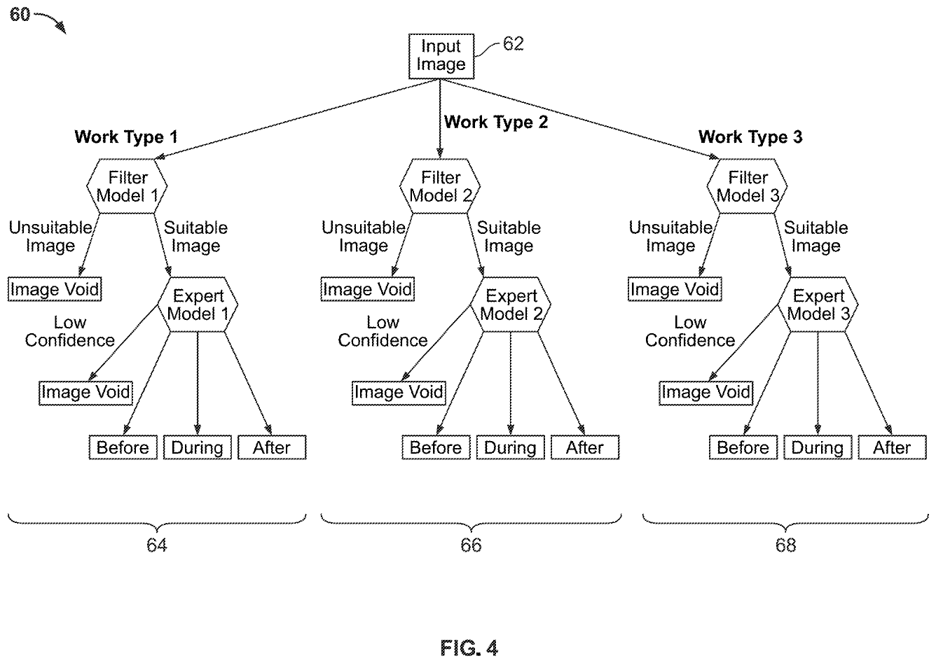

FIG. 4 is a flowchart 60 illustrating processing by the system of an input image using a plurality of hierarchical modeling processes 64, 66, and 68 executed in parallel where the type of workflow to be validated is not specified in advance. Specifically, in step 62, an input image 62 is received, and is processed in parallel by the modeling processes 64, 66, and 68. This parallel processing arrangement allows the system to process images that are not associated with a pre-defined type of work. The hierarchical workflow processes 64, 66, and 68 are similar to the process 30 of FIG. 2, in that each includes cascaded filter and expert models as described above in connection with FIG. 2.

Each of the hierarchical model processes described herein could include convolutional neural networks, transformers, or the like, in order to make a prediction as to the category of the image. For example, the systems/methods disclosed herein could utilize (but are not limited to) models such as EfficientNet, ConvNet, and ViT. Additionally, each module containing a model hierarchy for a particular work order can be trained independently. This allows for a reduction in labelling complexity while maximizing the accuracy for each specialist model. Training each module in such a manner also allows for an expansion of the covered work types without the need to re-train existing models. Models can be trained using supervised or unsupervised learning utilizing large volumes of data.

It is noted that post image-level validation of a work order can be automatically evaluated to be complete based on an aggregation of the per image results. This aggregation can be performed via a statistical or learned process and could incorporate the use of neural network based models. The aggregation can also be customized by the user of the system based on the customers desired outcome. For example, a customer may choose to automate a high volume of work orders with some tolerance for error. Another customer may choose to automate a lower volume of work orders but with higher precision. The system allows the user, with suggestion from the product, to select at what system confidence to consider a work order validated.

Moreover, as the system is built for the automated validation of work orders, it is of high importance to have in place automated flagging of potentially fraudulent activity. To this end, the system utilizes the metadata attached to each image to perform several checks related to assessing whether the image may have been manipulated. The system also utilizes a duplication check running at scale against all images previously sent through the product. Any input image is checked against the database of previous images with flagged duplicates being highlighted for manual review.

Users of the system can upload images via a customized user interface or utilize an on-device application. If a user utilizes an application to capture the imagery, the system guides the user as to how best to capture images suitable for the system. Doing so maximizes the volume of work orders to be automated by the system. The guided data capture process contains both instruction to the user and computer vision models giving real-time feedback to the user as to which frames contain imagery suitable for the work order that they are looking to upload. Once data is gathered, the system can process the work order either “online” or “offline”. Work orders processed “online” could utilize API microservices hosted on suitable computing infrastructure with results becoming available within the user interface of the system. Work orders validated “offline” utilize models running on devices without the need for an Internet connection.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A machine learning system for validating workflows, comprising;
a computing device receiving at least one digital image relating to work being performed by a contractor; and
a workflow validation software module executing on the computing device, the workflow validation software module:
processing the digital image using a filter machine learning model to determine whether the digital image is suitable for validating whether a work action has been completed; and
processing the digital image using an expert machine learning model to classify whether the digital image depicts a scene occurring before, during, or after performance of the work action.

2. The machine learning system of claim 1, wherein the workflow validation software module processes classification of the digital image by the expert machine learning model to validate completion of the work action.

3. The machine learning system of claim 1, wherein the workflow validation software module validates a location of the digital image.

4. The machine learning system of claim 3, wherein the workflow validation software module validates the location using semantic information contained within the digital image.

5. The machine learning system of claim 3, wherein the workflow validation software module validates the location of the digital image using metadata contained within the digital image.

6. The machine learning system of claim 3, wherein the workflow validation software module determines whether the location matches an address of a property.

7. The machine learning system of claim 1, wherein the workflow validation software module determines whether a time or date of the digital image matches a time or date of a proposed work order.

8. The machine learning system of claim 1, wherein the workflow validation software module performs image forensics on the digital image.

9. The machine learning system of claim 1, wherein at least one of the filter machine learning model or the expert machine learning model performs a Laplace Redux method.

10. The machine learning system of claim 1, wherein the workflow validation software module processes the input image based upon a pre-defined workflow type using one or more hierarchical machine learning processes.

11. The machine learning system of claim 1, wherein the workflow validation software module processes the digital image using a second cascaded expert model.

12. A machine learning method for validating workflows, comprising;
receiving at a computing device least one digital image relating to work being performed by a contractor;
processing the digital image using a filter machine learning model executed by the computing device to determine whether the digital image is suitable for validating whether a work action has been completed; and
processing the digital image using an expert machine learning model to classify whether the digital image depicts a scene occurring before, during, or after performance of the work action.

13. The machine learning method of claim 12 further comprising processing classification of the digital image by the expert machine learning model to validate completion of the work action.

14. The machine learning method of claim 12, further comprising validating a location of the digital image.

15. The machine learning method of claim 14, further comprising validating the location using semantic information contained within the digital image.

16. The machine learning method of claim 14, further comprising validating the location of the digital image using metadata contained within the digital image.

17. The machine learning method of claim 14, further comprising determining whether the location matches an address of a property.

18. The machine learning method of claim 12, further comprising determining whether a time or date of the digital image matches a time or date of a proposed work order.

19. The machine learning method of claim 12, further comprising performing image forensics on the digital image.

20. The machine learning method of claim 12, wherein at least one of the filter machine learning model or the expert machine learning model performs a Laplace Redux method.

21. The machine learning method of claim 12, further comprising processing the input image based upon a pre-defined workflow type using one or more hierarchical machine learning processes.

22. The machine learning method of claim 12, further comprising processing the digital image using a second cascaded expert model.
